(19) United States
(12) Patent Application Publication
(10) Pub. No.: US 2009/0317696 A1
(43) Pub. Date: Dec. 24, 2009

(54) Compound battery device having lithium battery and lead-acid battery

(76) Inventor: Chih-Peng Chang, Taichung City (TW)

Correspondence Address: Raymond Sun, 12420 Woodhall Way, Tustin, CA, 92782, US

(21) Appl. No.: 12/214,472

(22) Filed: Jun. 19, 2008

(51) Int. Cl. H01M 2/20

(52) U.S. Cl. 429/61

(57) ABSTRACT

A compound battery device having a lithium battery and a lead-acid battery includes at least one lithium battery unit, at least one lead-acid battery unit and a control circuit. The lithium and lead-acid battery units are electrically connected in parallel and can have various combinations to meet actual demands of an output voltage. The control circuit is electrically connected to the lithium and lead-acid battery units separately and further comprises a voltage-boosting unit, a voltage-detecting unit, a lithium battery unit management unit and a logic control unit. Thereby, two complementary battery units are connected in parallel, with a control circuit to adjust a voltage thereof, allowing the two battery units to work together to make use of their respective advantages while providing mutual power support. Thus, the compound battery device is capable of more efficient power supply and higher loading, and effectively prevents over-discharge that shortens the battery service life.

### BACKGROUND OF INVENTION

1. Field of the Invention

The present invention relates to a compound battery device having a lithium battery and a lead-acid battery, and more particularly, to a compound battery device having a lithium battery and a lead-acid battery integrated with one another in power supply so as to make use of the respective advantageous features of the two batteries.

2. Description of the Prior Art

With the progress and development of technology, new techniques are constantly developed and applied to make higher-quality and more refined products. Particularly, as oil prices soar and environmental awareness thrives, environment-friendly and power-saving products have been continuously devised and manufactured. For instance, the industry has invested heavily on the research and development of the means of transportation, which are directly associated with the use of gasoline, and the efforts have been focused on, among others, electric cars, electric motorcycles and electric bicycles. Electric cars have such problems as a limited operating time and insufficient driving power so that further research is required to get through the technical bottleneck. On the other hand, both electric motorcycles and electric bicycles have entered the stage of mass production and commoditization. Driven by pedaling as well as an electric motor, an electric bicycle does not have the problem of a short operating time because, even when electricity is low, it can still be pedaled on to its destination. Besides, electric bicycles are well accepted as a means for short-distance travel and therefore not expected of a high driving power and speed. Therefore, electric bicycles have been the most popular electric vehicles on the market.

As to electric motorcycles, although progress has been made to certain extent, the problems associated with battery, such as insufficient battery endurance and inconvenience in recharging, remain unsolved. Therefore, despite government promotion and even subsidy for buying electric motorcycles, people are still skeptical in responding to such an environment-friendly policy. To solve the aforesaid problems, U.S. Pat. No. 7,148,637 discloses a portable compound battery unit management system comprising a portable high-capacity battery unit A, an external battery charger B, a main power battery unit C disposed on an electric vehicle, and a DC converter D, as shown in FIG. 1. The portable high-capacity battery unit A is an expensive high-capacity light-weighted lithium battery generally used in portable electronic products on the market, such as cell phones, notebook computers, etc. Because of its portability, the portable high-capacity battery unit A can be separately and conveniently carried home by its user to be recharged by the external battery charger B. Then, the high-capacity battery unit A is coupled to the main power battery unit C for the DC converter D to adjust a voltage difference therebetween, so that the high-capacity battery unit A is allowed to charge the main power battery unit C, which is disposed on the electric vehicle and more difficult to recharge. Meanwhile, the high-capacity battery unit A can work in conjunction with the main power battery unit C to supply power simultaneously, thereby solving the commonly encountered problem of conventional electric vehicles that they are difficult to recharge. While the structural design described above solves the problem that conventional electric vehicles cannot be easily recharged, today's electric vehicles, in fact, face more problems than those associated with power supply techniques. Battery consumption is another obstacle to be overcome. Specifically, a lithium battery, though having such advantages as a high capacity, a small volume and a light weight, is not suitable for outputting a large transient current and has a relatively high cost. On the contrary, a lead-acid battery is advantageous in being fit for outputting a large transient current and having a lower cost, though it has a large volume, a heavier weight that prevent it from being easily moved, and a large voltage drop. Therefore, it is an urgent research and development issue in the relevant industry to provide an electric vehicle with a power supply battery capable of large current output and long-lasting power supply and available at a reasonable price.

### SUMMARY OF INVENTION

It is a primary objective of the present invention to provide a compound battery device having a lithium battery and a lead-acid battery, wherein a high-capacity lithium battery capable of power supply for a long time is integrated with a low-priced lead-acid battery suitable for large current output, and a control device is used to increase discharge efficiency, operating time and hill-climbing capabilities.

A secondary objective of the present invention is to provide a compound battery device having a lithium battery and a lead-acid battery, wherein, when the lead-acid battery is so heavily loaded that its transient power supply voltage drop increases, a control device can increase a voltage of the lithium battery in a timely manner to support the lead-acid battery in power supply, thereby preventing the lead-acid battery from being damaged by over-discharge, so that the batteries are allowed to have longer service lives.

To achieve these objectives, a compound battery device having a lithium battery and a lead-acid battery according to the present invention comprises at least one lithium battery unit, at least one lead-acid battery unit and a control circuit, wherein the lithium battery unit and the lead-acid battery unit can have various combinations to meet actual demands of an output voltage, while the control circuit is electrically connected to the lithium battery unit and the lead-acid battery unit separately and further comprises a voltage-boosting unit, a voltage-detecting unit, a lithium battery unit management unit and a logic control unit.

### BRIEF DESCRIPTION OF THE DRAWINGS

The invention as well as a preferred mode of use, further objectives and advantages thereof will best be understood by reference to the following detailed description of an illustrative embodiment when read in conjunction with the accompanying drawings, wherein:

FIG. 1 is a schematic diagram showing a conventional battery structure;

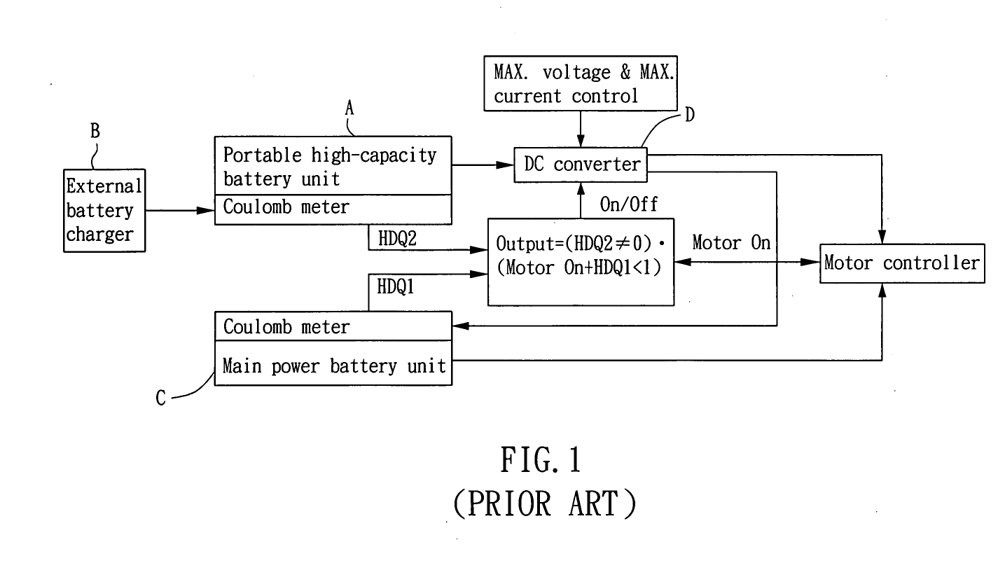

FIG. 2 is a schematic diagram showing a compound battery device according to the present invention;

FIG. 3 is a plot showing voltage raising of a lithium battery unit according to the present invention; and

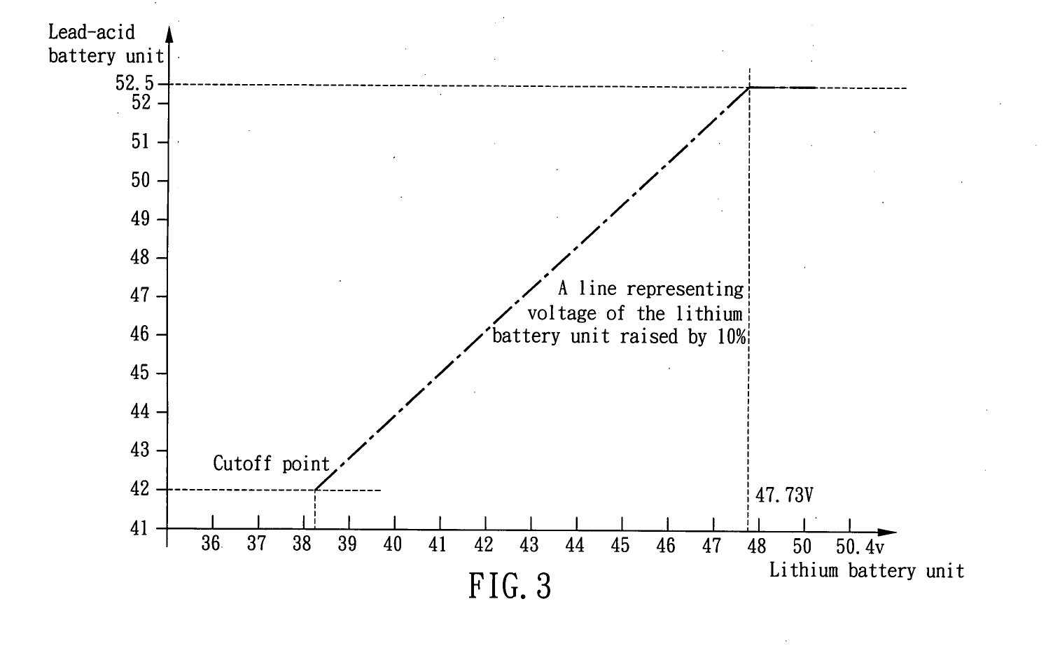

FIG. 4 is a circuit diagram of the compound battery device according to the present invention.

### DETAILED DESCRIPTION OF PREFERRED EMBODIMENTS

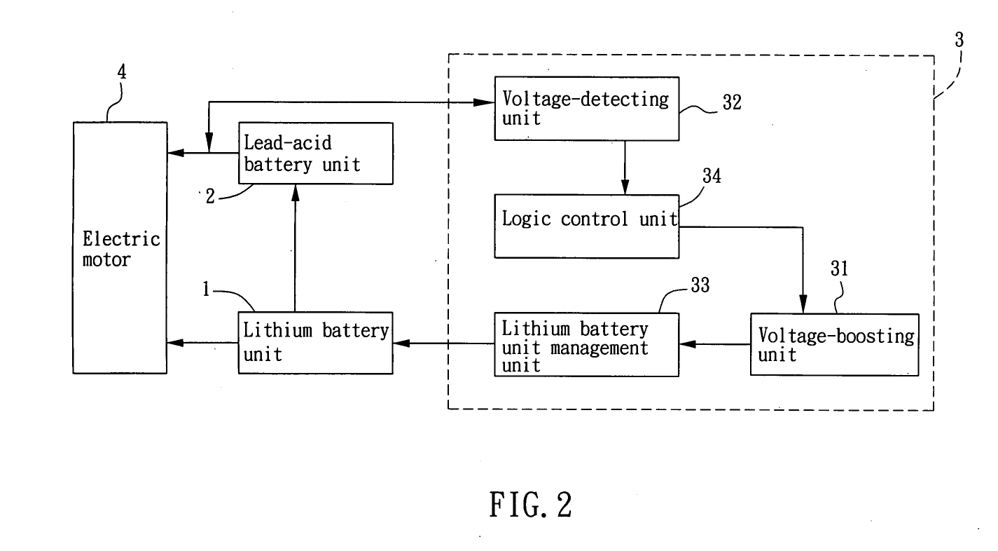

Referring first to FIG. 2, which is a schematic diagram showing a compound battery device according to the present invention, the compound battery device having a lithium battery and a lead-acid battery essentially comprises at least one lithium battery unit 1, at least one lead-acid battery unit 2 and a control circuit 3, wherein the lithium battery unit 1 and the lead-acid battery unit 2 can have various combinations to meet actual demands of an output voltage, while the control circuit 3 is electrically connected to the lithium battery unit 1 and the lead-acid battery unit 2 separately and further comprises a voltage-boosting unit 31, a voltage-detecting unit 32, a lithium battery unit management unit 33 and a logic control unit 34.

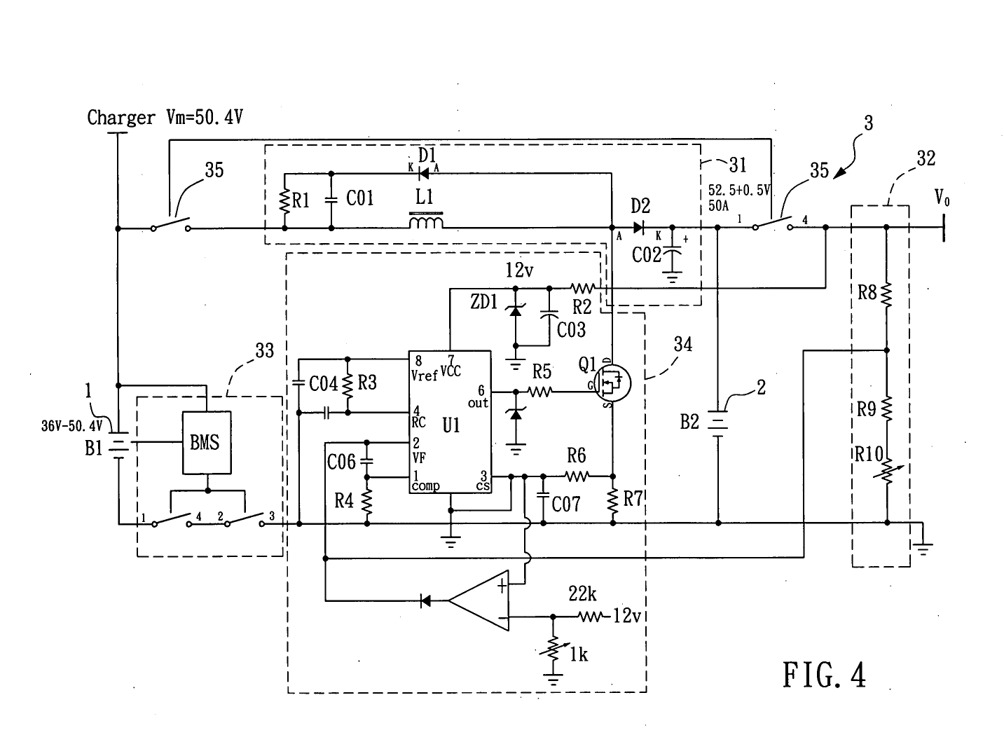

Referring now to FIGS. 2 and 4, which are a schematic diagram and a circuit diagram of a preferred embodiment of the present invention, respectively, the lead-acid battery unit 2 comprises four series-connected lead-acid batteries and has a voltage of 48 V while the lithium battery unit 1 comprises twelve series-connected lithium batteries and has a voltage of 45.6 V. When the compound battery device of the present invention is recharged, two non-fuse circuit breakers 35 must be connected, respectively, so that the lithium battery unit 1 is recharged with a maximum voltage of 50.4 V and the lead-acid battery unit 2 is recharged with a voltage raised by the voltage-boosting unit 31 in the control circuit 3 to 52.4 V or above. During the various operations of the lithium battery unit 1, the lithium battery unit management unit 33 not only serves a circuit-breaking function to prevent over-charge and over-discharge, but also provides such functions as circuit balancing and temperature control. The lithium battery unit 1 has an original operating voltage ranging from 50.4 V to 36 V, which is raised by the voltage-boosting unit 31 to 52.5 V to 42 V, so as to be very close to an operating voltage range of the lead-acid battery unit 2. The voltage-detecting unit 32 is used mainly to detect an output voltage of the lead-acid battery unit 2. For example, when an electric motor 4 of an electric vehicle using the compound battery device of the present invention incurs a higher load on the lead-acid battery unit 2 during startup or an uphill operation, the lead-acid battery unit 2 will experience an increased transient power supply voltage drop. The voltage-detecting unit 32 can detect such voltage drop, allowing the logic control unit 34 to drive the voltage-boosting unit 31 instantly, so that the voltage of the lithium battery unit 1 is raised to support the lead-acid battery unit 2 in power supply. Taking the preferred embodiment of the present invention as an example, the lead-acid battery unit 2 and the lithium battery unit 1 have very similar available capacities, wherein the lead-acid battery unit 2 is rated at 22 Ah (discharging at 1 C for 40 minutes) and the lithium battery unit 1 is rated at 14.5 Ah (discharging at 1 C for more than 55 minutes). The voltage-detecting unit 32 takes voltage samples at two ends of the lead-acid battery unit 2, allowing the voltage-boosting unit 31 to raise the voltage of the lithium battery unit 1 to the same level as the voltage of the lead-acid battery unit 2. When the load is increased to a current-limiting value of 50 A, the lead-acid battery unit 2 has a higher voltage drop due to internal resistance. In order to stabilize the voltage of the lead-acid battery unit 2, the output of the lithium battery unit 1 is increased to enhance power supply efficiency. As soon as the voltage of the lithium battery unit 1 drops to 38.18 V, which is a cutoff point, the logic control unit 34 controls circuit breaking to provide lower-voltage protection, so that the service life of the lead-acid battery unit 2 will not be shortened due to over-discharge.

The compound battery device having the lithium battery and the lead-acid battery according to the present invention can be installed in an electric vehicle, so that while the vehicle is in operation, the control circuit 3 allows the lithium battery unit 1 and the lead-acid battery unit 2, which have different voltages, different load powers and different charging and discharging conditions, to be connected in parallel to make the best of their respective advantages in response to different road conditions and the requirements of the driving mechanism. Thus, not only is the overall discharge efficiency enhanced to increase operating time and hill-climbing capabilities, but also the battery units in charge of power supply are effectively protected from being damaged by over-discharge.

In addition, the lithium battery unit 1 disclosed in the present invention is a lithium-ion battery, or a lithium-polymer battery which is more stable than the lithium-ion battery.

In the structure described above, the voltage-boosting unit 31 in the control circuit 3 serves mainly to raise the voltage of the lithium battery unit 1 by up to 13%, so that the raised voltage of the lithium battery unit 1 matches the voltage of the lead-acid battery unit 2. It should be noted that a limit for the voltage-boosting range of the voltage-boosting unit 31 is set chiefly in consideration of the stability and safety of the voltage-boosting unit 31. According to actual applications and experiments, when the voltage-boosting range is too large, the entire circuit will become unstable as the working temperature is hard to control. Therefore, a limiting condition is set for the voltage-boosting unit 31 to produce a stabilizing effect and increase the safety of the entire product. However, the limiting condition for the voltage-boosting unit 31 also has considerable impact on the combinations of the lithium battery unit 1 and the lead-acid battery unit 2 of the present invention.

Since the voltage-boosting range of the voltage-boosting unit 31 is limited to no more than 13%, such limit must be sufficiently considered when choosing and matching the lithium battery unit 1 and the lead-acid battery unit 2. Tests were conducted according to the various power supply voltage requirements of electric motors employed in commercially available electric vehicles to obtain the following preferred combinations: (1) five series-connected lead-acid batteries having a total voltage of 60 V and 14 (or more) series-connected lithium batteries having a nominal voltage of 53.2 V; (2) four series-connected lead-acid batteries having a total voltage of 48 V and 12 (or more) series-connected lithium batteries having a nominal voltage of 45.6 V; (3) three series-connected lead-acid batteries having a total voltage of 36 V and 8 (or more) series-connected lithium batteries having a nominal voltage of 30.4 V; and (4) two series-connected lead-acid batteries having a total voltage of 24 V and five (or more) series-connected lithium batteries having a nominal voltage of 19 V.

According to the aforementioned structure of the compound battery device having the lithium battery and the lead-acid battery, two kinds of complementary battery units, i.e., the lithium battery unit 1 and the lead-acid battery unit 2, are electrically connected in parallel and provided with the control circuit 3 to adjust a voltage thereof, so that the two kinds of battery units can work complementarily with each other to make the best of their respective advantages and provide mutual power support. Thus, not only is the power supply efficiency greatly enhanced, but also the load capacities of the battery units are increased as a whole. Besides, over-discharge is effectively prevented to keep internal voltages of the batteries from rising, so that the reversibility of active substances at the anodes and cathodes of the batteries will not be impaired. Consequently, the capacities of the batteries will not be noticeably reduced and thereby shorten the service lives of the batteries.

In conclusion, the compound battery device having the lithium battery and the lead-acid battery according to the present invention allows the complementary lithium battery unit 1 and lead-acid battery unit 2 to form parallel connection and uses the control circuit 3 to adjust a voltage thereof, so as to make use of their respective advantages while effectively overcoming the drawbacks associated with their being independently used in the conventional way.

Although a preferred embodiment of the invention has been described for purposes of illustration, it is understood that various changes and modifications to the described embodiment can be carried out without departing from the scope and the spirit of the invention as disclosed in the appended claims.

What is claimed is:

1. A compound battery device having a lithium battery and a lead-acid battery, comprising:
at least one lithium battery unit;
at least one lead-acid battery unit; and
a control circuit,
wherein the lithium battery unit and the lead-acid battery unit are electrically connected in parallel and can have various combinations to meet actual demands of an output voltage; and the control circuit is electrically connected to the lithium battery unit and the lead-acid battery unit separately and further comprises a voltage-boosting unit, a voltage-detecting unit, a lithium battery unit management unit and a logic control unit.

2. The compound battery device as claimed in claim 1, wherein a voltage of the lead-acid battery unit is automatically detected as a reference point, so that a voltage of the lithium battery unit is raised accordingly by the voltage-boosting unit to be equal to the voltage of the lead-acid battery unit.

3. The compound battery device as claimed in claim 2, wherein the voltage-boosting unit has a voltage-boosting range from 0 to 13%.

4. The compound battery device as claimed in claim 1, wherein the lithium battery unit is one of a lithium-ion battery and a lithium-polymer battery.

5. The compound battery device as claimed in claim 1, wherein one of the various combinations of the lithium battery unit and the lead-acid battery unit comprises five series-connected lead-acid batteries having a total voltage of 60 V and fourteen series-connected lithium batteries having a nominal voltage of 53.2 V.

6. The compound battery device as claimed in claim 1, wherein one of the various combinations of the lithium battery unit and the lead-acid battery unit comprises four series-connected lead-acid batteries having a total voltage of 48 V and twelve series-connected lithium batteries having a nominal voltage of 45.6 V.

7. The compound battery device as claimed in claim 1, wherein one of the various combinations of the lithium battery unit and the lead-acid battery unit comprises three series-connected lead-acid batteries having a total voltage of 36 V and eight series-connected lithium batteries having a nominal voltage of 30.4 V.

8. The compound battery device as claimed in claim 1, wherein one of the various combinations of the lithium battery unit and the lead-acid battery unit comprises two series-connected lead-acid batteries having a total voltage of 24 V and five series-connected lithium batteries having a nominal voltage of 19 V.
